(19) United States
(12) Patent Application Publication
(10) Pub. No.: US 2022/0188364 A1
(43) Pub. Date: Jun. 16, 2022

(54) CHAT SYSTEM AND CHAT PROGRAM

(71) Applicant: Sciseed Inc., Tokyo (JP)

(72) Inventor: Kotaro ANDO, Tokyo (JP)

(21) Appl. No.: 17/541,662

(22) Filed: Dec. 3, 2021

(30) Foreign Application Priority Data
Dec. 14, 2020 (JP) 2020-206501

(51) Int. Cl. G06F 16/9032; H04L 51/00

(52) U.S. Cl. CPC G06F 16/90332; H04L 51/16

(57) ABSTRACT

A chat system includes: a user answer acquisition unit that, when a question is received from a user who is questioner, transmits the question to a plurality of other users to acquire answers from the plurality of other users; and an answering unit that answers the questioner by using any of the answer, content stored in a database of a conversation data storage unit and the answer content obtained from the plurality of other users. By selecting any of the answer content stored in the database and the answer content obtained from, the plurality of other users, a more appropriate answer can be provided to the questioner.

### BACKGROUND OF THE INVENTION

### Field of the Invention

The present invention relates to a chat system and a chat program, and in particular, it is suitable for use in a system that automatically engages in conversations with humans.

### Description of the Related Art

In recent years, a program for automatically engaging in conversations with humans through text or voice, a so-called chatbot, has been drawing attention and is being widely used. Many chatbots analyze the content of questions or remarks entered by users and generate answers to reply thereto. There are chatbots including a type that has a selective conversation according to a predetermined scenario, a type that makes a response close to the context by using a conversation log, and the like.

Furthermore, a system that uses both computer-based answers and human-based answers is also known (see, for example, JP-A-2001-216324). JP-A-2001-216324 discloses that an answer is given from either a database or an answerer based on the degree of suitability between the question content and an answer group in the database. In the question answering system described in JP-A-2001-216324, the suitability of transmitting a question sent by a user to an answer database (the degree cl suitability of the answer group for a question) Is determined based on the question content, the question is transmitted to either the database or the answerer interface according to the determination result, and the answer to the transmitted question is received from the database or the answerer interface and transmitted.

According to the question answering system described in JP-A-2001-216324, when there is no answer having a high degree of suitability for the question content In the database, it is possible to obtain an answer from an answerer and transmit the answer to the questioner. However, there is a problem that the answer given by the answerer is not always appropriate.

### SUMMARY OF THE INVENTION

The invention has been made to solve such a problem, and it is an object of the invention to provide a more appropriate answer to a questioner.

In order to solve the aforementioned problem, in the invention, when a question is received from a terminal of a user who is a questioner, the question is transmitted to terminals of a plurality of other users excluding the questioner to obtain answers from the plurality of other users, and the questioner is answered by using any of the answer content stored in a database of a conversation data storage unit and the answer content obtained from, the plurality of other users.

According to the invention configured as described above, answers are obtained from a plurality of users, and any of the answer content stored in the database and the answers obtained from the plurality of users is selected and used to answer the questioner. Therefore, it is possible to provide a more appropriate answer to the questioner than in a case where the answer is obtained from only one user.

### BRIEF DESCRIPTION OF THE DRAWINGS

FIG. 1 is a diagram, showing an example of the overall configuration of a chat system according to a first embodiment;

FIG. 2 is a block diagram showing a functional configuration example of a server apparatus according to the first embodiment;

FIG. 3 is a diagram showing an operation example of the chat system according to the first embodiment;

FIG. 4 is a block diagram showing a functional configuration example of a server apparatus according to a second embodiment;

FIG. 5 is a diagram showing an operation example of the chat system according to the second embodiment;

FIG. 6 is a block diagram showing a functional configuration example of a server apparatus according to a third embodiment; and

FIG. 7 is a diagram showing an operation example of the chat system according to the third embodiment.

### DETAILED DESCRIPTION OF THE INVENTION

### First Embodiment

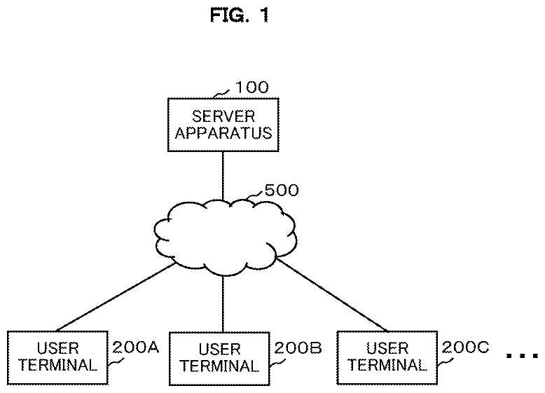

Hereinafter, a first embodiment of the invention will be described with reference to the diagrams. FIG. 1 is a diagram showing an example of the overall configuration of a chat system according to the first embodiment. As shown in FIG. 1, the chat system of the present embodiment includes a server apparatus 100 and a plurality of user terminals 200A, 200B, 200C, . . . (hereinafter, referred to as a user terminal 200 when not particularly distinguished). The server apparatus 100 and the user terminal 200 are connected to each other through a communication network 500, such as the Internet or a mobile phone network.

The server apparatus 100 functions as a so-called chatbot, and automatically has a conversation with a user who uses the user terminal 200. In the first embodiment, basically, the server apparatus 100 transmits an answer stored in advance in a database in response to a question transmitted from the user terminal 200. However, when an appropriate answer to the question is not present in the database, the question is transmitted to a plurality of user terminals 200 used by other users different from the questioner, a plurality of answers are obtained from the plurality of other users, and one of the answers that meets the predetermined determination criteria is selected to answer the questioner.

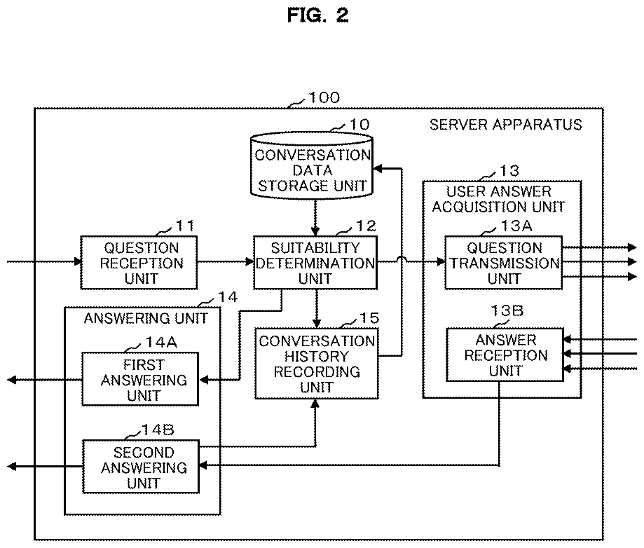

FIG. 2 is a block diagram showing a functional configuration example of the server apparatus 100 according to the first embodiment. As shown in FIG. 2, the server apparatus 100 according to the first embodiment includes a question reception unit 11, a suitability determination unit 12, a user answer acquisition unit 13, an answering unit 14, and a conversation history recording unit 15 as functional components. The user answer acquisition unit 13 includes a question transmission unit 13A and an answer reception unit. 13B as specific functional components. Furthermore, the answering unit 14 includes a first answering unit 14A and a second answering unit 14B as specific functional components. Furthermore, the server apparatus 100 according to the first embodiment includes a conversation data storage unit 10 as a storage medium.

The functional blocks 11 to 15 can be configured by any of hardware, a digital signal processor (DSP), and software. For example, when configured by software, the functional blocks 11 to 15 is actually configured to include a CPU, a RAM, and a BOM of a computer, and is realized by the operation of a chat program stored in a recording medium, such as a RAM, a ROM, a hard disk, or a semiconductor memory.

The conversation data storage unit 10 stores the question content and the answer content as a database in association with each other. The conversation data storage unit 10 stores a plurality of expected question contents and a plurality of answer contents, which are expected for the plurality of expected question contents, in advance so as to be associated with each other. Furthermore, as will be described in detail later, in the conversation data storage unit 10, a combination of question contents and answer contents that is not present in the original database is stored by being added by the conversation history recording unit 15.

The question reception unit 11 receives a question from the user terminal 200 used by the user who is a questioner. The questioner can be any of users A, b, C, . . . using the user terminals 200A, 200B, 200C, . . . . Note that, for the sake of simplicity, a case where the user A of the user terminal 200A is a questioner will be described below.

When the question reception unit 11 receives a question, the suitability determination unit 12 determines the suitability of using the answer content stored in the conversation data storage unit 10 as an answer to the question. For example, the suitability determination unit 12 calculates the similarity between the content of the question received by the question reception unit 11 and the content of a plurality of questions stored in the conversation data storage unit 10, and determines whether or not there is a question content having a similarity equal to or higher than a predetermined level. Then, when there is a question content, having a similarity equal to or higher than the predetermined level, it is determined that it is appropriate to use the answer content stored in association with the question content. On the other hand, when there is no question content having a similarity equal to or higher than the predetermined level, it is determined that, it is not appropriate to use the answer content stored in the conversation data storage unit 10.

Here, the similarity of the question content can be calculated by using a known technique. For example, it is possible to use a method in which a sentence of a question content is morphologically analyzed to extract a plurality of words, a sentence vector is calculated from a combination of the extracted words according to a predetermined quantification rule, and the similarity of the sentence vector is calculated. When calculating the similarity of the sentence vector, a feature amount may be extracted from the sentence vector by using a predetermined function, and the similarity of the feature amount may be evaluated. Alternatively, the Euclidean distance or cosine similarity calculated for a plurality of element values configuring the sentence vector may be used, or the edit distance may be used.

When the suitability determination unit 12 determines that it is not appropriate to use the answer content stored in the conversation data storage unit 10, the user answer acquisition unit 13 transmits the question to the user terminals 200B, 200C, . . . used by a plurality of other users B, C, . . . excluding the user A, who is a questioner, to obtain answers from the plurality of other users B, C, . . . . The answering unit 14 answers the user A who is a questioner by using any of the answer content stored in the conversation data storage unit 10 and the answer content obtained from the plurality of other users B, C, . . . by the user answer acquisition unit 13.

Specifically, when the suitability determination unit 12 determines that it is appropriate to use the answer content stored in the conversation data storage unit 10, the first answering unit 14A answers the user A who is a questioner by using the answer content stored in the conversation data storage unit 10. That is, the data of the answer content is transmitted to the user terminal 200A. Here, there is a case where a plurality of question contents having a similarity equal to or higher than a predetermined level are stored in the conversation data storage unit 10. In this case, the first answering unit 14A answers the questioner by using the answer content stored in association with the question content having the highest similarity, for example.

On the other hand, when the suitability determination unit 12 determines that it is not appropriate to use the answer content stored, in the conversation data storage unit 10, the question transmission unit 13A transmits the question received by the question reception unit 11 to the plurality of user terminals 200B, 200C, . . . excluding the user terminal 200A. Here, the user terminals 200B, 200C, . . . to which the question is to be transmitted are terminals connected to the communication network 500 at the time of transmission. Note that, the question may be transmitted to all of the other user terminals 200B, 200C, . . . connected to the communication network 500, or the question may be transmitted to some user terminals 200. When transmitting the question to some user terminals 200, the user terminals 200 to which the question is to be transmitted may be randomly selected, or may be selected according to the predetermined selection criteria.

The answer reception unit 13B receives the answers transmitted from the plurality of user terminals 200B, 200C, . . . to which the question has been transmitted. These answers are input by operating an input device, such as a keyboard or a touch panel, by the users B, C, . . . who use the user terminals 200B, 200C, . . . when the users B, C, . . . see the question. Here, not all of the plurality of users B, C, . . . who have received the question transmission transmit answers. Furthermore, the timing of transmitting the answer varies. Therefore, the answer reception unit 13B sequentially supplies the received answers to the second answering unit 14B each time the answers transmitted from the plurality of user terminals 200B, 200C, . . . are received. Furthermore, the answer reception unit 13B receives only the answers transmitted within the time-out time from the time when the question transmission unit 13A transmits the question.

The second answering unit 14B selects one of the plurality of answers received by the answer reception unit 13B within the time-out time, which meets the predetermined determination criteria. The predetermined determination criteria can be set arbitrarily. For example, a plurality of determination items are set, the scores of the answers received from the plurality of user terminals 200B, 200C, . . . are calculated according to whether or not the answer content satisfies the determination items, and the answer having the highest score is selected from the answers. Note that, when there is no answer having a score equal to or higher than the predetermined value, none of the answers may foe selected.

Furthermore, the score may be calculated by the learning model generated by machine learning. For example, in the original initial state in which the operation of the chat system starts, scoring is performed based on random numbers or the above-described determination items, and questions and answers actually exchanged between users during the operation are sequentially accumulated as data sets. Then, teacher data is generated by using data with good questioners' responses to the answer in the accumulated data set as a positive example, and machine learning is performed using the teacher data. The data with good questioners' responses is, for example, data returned with positive content for the answer.

Here, the learning model can be, for example, a model, in which the score increases as the number of simple characters in the answer increases. Alternatively, a model may foe used in which words included in the answer content are analyzed by using dictionary data that defines positive words and negative words and the score increases as the number of positive words included in the answer increases. Alternatively, a model may be used in which the emotion of the answerer is estimated from the answer content and the score increases as the degree of positive emotion increases.

As another example, the second answering unit 14B may calculate the score of the answer each time the answer is supplied from the answer reception unit 13B and select the answer immediately when the score is equal to or higher than the predetermined value. According to this configuration, the response of the answer to the questioner can be made as fast as possible.

The second answering unit 14B transmits the answer selected as described above to the user terminal 200A of the user A who is a questioner. Note that, when no answer is selected because there is no answer having a score equal to or higher than the predetermined value, the second answering unit 14B does not transmit the answer, to the user terminal 200A. Alternatively, an answer to the effect, that an appropriate answer cannot be found may be transmitted.

The conversation history recording unit 15 adds and stores the content of the question (question when the suitability determination unit 12 determines that it is not appropriate to use the answer content stored in the conversation data storage unit 10 as an answer to the question), which is received from the questioner by the question reception unit 11, and the content of the answer (answer selected from the answers obtained from the plurality of users B, C, . . . ), which is given to the questioner by the second answering unit 14B, in the database of the conversation data storage unit 10 so as to be associated with each other. In this manner, by adding and storing the combination of the question content and the answer content that is not present in the original database by the conversation history recording unit 15, it is possible to increase the possibility that the first answering unit I4A can answer simply by using the database thereafter. Since the answer content additionally stored in the conversation data storage unit 10 satisfies the predetermined determination criteria, it can be said that the answer content additionally stored in the conversation data storage unit 10 is suitable as the answer content.

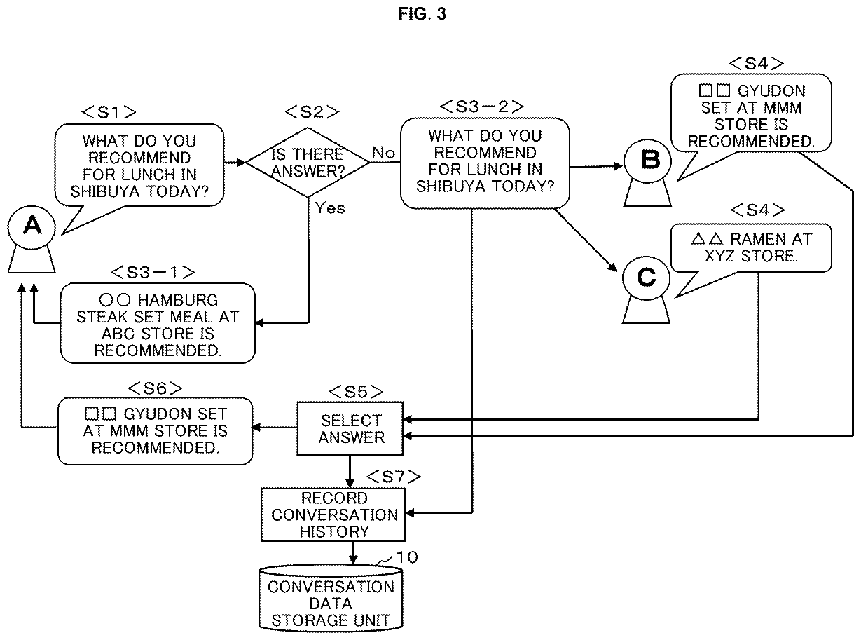

FIG. 3 is a diagram showing an operation example of the chat system according to the first embodiment configured as described above. In FIG. 3, first, the user A who is a questioner transmits a question from the user terminal 200A to the server apparatus 100 (step S1). In the example shown in FIG. 3, the user A transmits a question “What do you recommend for lunch in Shibuya today?”.

In the server apparatus 100, when the question reception unit 11 receives this question from the user terminal 200A, the suitability determination unit 12 determines the suitability of using the answer content stored in the conversation data storage unit 10 as an answer to the question received by the question reception unit 11 (step S2).

Here, when the suitability determination unit 12 determines that it is appropriate to use the answer content stored in the conversation data storage unit 10, the first answering unit 14A answers the user A by using the answer content stored in the conversation data storage unit 10 (step S3-1). In the example shown in FIG. 3, the first answering unit 14A transmits an answer “◯◯ hamburg steak set meal at the ABC store is recommended”.

On the other hand, when the suitability determination unit 12 determines that it is not appropriate to use the answer content stored in the conversation data storage unit 10, the question transmission unit 13A transmits the question received by the question reception unit 11 to the plurality of user terminals 200B, 200C, . . . other than the user terminal 200A (step S3-2). The users B, C, . . . who have received the question transmission input answers to the user terminals 200B, 200C, . . . , and transmit the answers to the server apparatus 100 (step S4). In the example shown in FIG. 3, the user B transmits an answer “□□ Gyudon set at the MMM store is recommended”, and the user C transmits an answer “ΔΔ Ramen at the XYZ store”.

In the server apparatus 100, when the answer reception unit 13B sequentially receives these answers from the plurality of user terminals 200B, 200C, . . . , the second answering unit 14B selects one answer that, meets the predetermined determination criteria (step S5). In the example shown in FIG. 3, the second answering unit 148 selects the answer “□□ Gyudon set at the MMM store is recommended” received from the user terminal 200B.

Then, the second answering unit 14B transmits the answer selected as described above to the user terminal 200A of the user A who is a questioner (step S6). Furthermore, the conversation history recording unit 15 adds and stores the content of the question (“What do you recommend for lunch in Shibuya today”) received from the questioner by the question reception unit 11 and the content of the answer (“□□ Gyudon set at the MMM store is recommended”) selected by the second answering unit 14B in the database of the conversation data storage unit 10 so as to be associated with each other (step S7).

As described, in detail above, in the server apparatus 100 of the first embodiment, when a question is received from the user terminal 200A of the user A who is a questioner, the suitability of using the answer content stored in the conversation data storage unit 10 as an answer to the question is determined, and the user A is answered by using the answer content of the database when it is determined that it is appropriate to use the answer content. On the other hand, when it is determined that it is not appropriate to use the answer content stored in the conversation data storage unit 10, the question is transmitted to the user terminals 200B, 200C, . . . of the plurality of; other users B, C, . . . excluding the user A to obtain a plurality of answers from the plurality of other users B, C, . . . , and one of the answers that meets the predetermined determination criteria is selected to answer the user A.

According to the first embodiment configured in this manner, even if there is no answer having a high degree of suitability for the question content in the database of the conversation data storage unit 10 and accordingly it is not appropriate to use the answer content of the database, answers are obtained from the plurality of users B, C, . . . , and an answer that meets the predetermined determination criteria among the obtained answers is selected and used to answer the user A who is a questioner. Therefore, it is possible to provide a more appropriate answer to the questioner than in a case where the answer is obtained from only one user.

### Second Embodiment

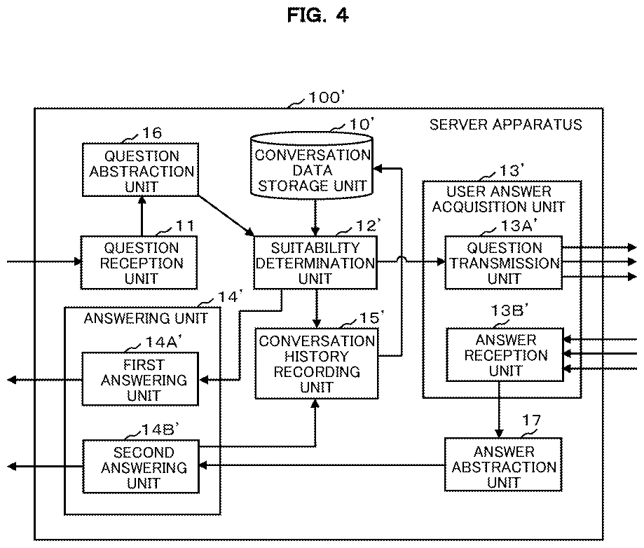

Next, a second embodiment of the invention will be described with reference to the diagrams. The overall configuration of a chat system according to the second embodiment is the same as that in FIG. 1. A server apparatus 100′ is used instead of the server apparatus 100. FIG. 4 is a block diagram showing a functional configuration example of the server apparatus 100′ according to the second embodiment. in FIG. 4, components denoted by the same reference numerals as those shown in FIG. 2 have the same functions, and accordingly, repeated description thereof will be omitted.

As shown in FIG. 4, the server apparatus 100′ according to the second embodiment further includes a question abstraction unit 16 and an answer abstraction unit 17 as functional components. Furthermore, the server apparatus 100′ according to the second embodiment includes a conversation data storage unit 10′, a suitability determination unit 12′ user answer acquisition unit 13′, an answering unit 14′, and a conversation history recording unit 15′ instead of the conversation data storage unit 10, the suitability determination unit 12, the user answer acquisition unit 13, the answering unit 14, and the conversation history recording unit 15 shown in FIG. 2.

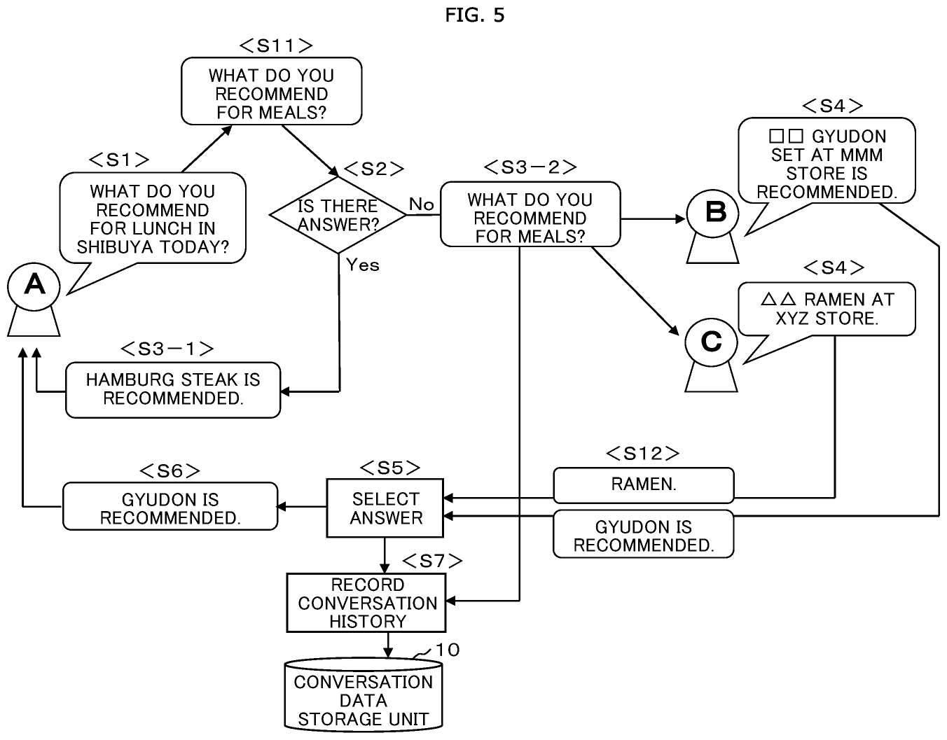

FIG. 5 is a diagram showing an operation example of the chat, system according to the second embodiment. In FIG. 5, since a portion to which the same number as the step number shown in FIG. 3 is assigned has the same processing, repeated description thereof will be omitted herein. Hereinafter, the second embodiment will be described with reference to FIGS. 4 and 5.

When a question from the questioner that is transmitted from the user terminal 200 is received by the question reception unit 11, the question abstraction unit 16 analyzes the content of the question and replaces the question with an abstract question having a higher degree of abstraction. In the example of FIG. 5, the question abstraction unit 16 replaces the question “What do you recommend for lunch in Shibuya today?” received from the user A with an abstract question “What do you recommend for meals?” (step S11).

The algorithm for abstracting the question content can be, for example, as follows. That is, the sentence of the question received by the question reception unit 11 is morphologically analyzed to extract a plurality of words, and the part of: speech of the extracted words is specified. Then, among the plurality of extracted words, words representing time, words representing places and positions, and particles (in the above example, “today”, “of”, “Shibuya”, and “in”) connected to these are omitted, furthermore, adverbs, adnominal adjectives, conjunctions, interjections, and demonstratives are omitted. For nouns, verbs, adjectives, and determination words, words of subordinate concept are replaced with words of: superordinate concept if: possible (in the above example, “lunch” is replaced with “meal”). Proper nouns are omitted or replaced with general nouns. In performing the above processing, dictionary data showing the relationship between the word and the part of speech and the relationship between the superordinate concept and the subordinate concept is used.

Note that, the algorithm described herein is merely an example. For example, the algorithm may be as follows. That is, a large number of: sets of abstract questions that have already been abstracted and a plurality of words serving as keywords are prepared in advance. Then, it is determined how many keywords are included in the sentence of the question received by the question reception unit 11, and an abstract question including the largest number of keywords in the question sentence is adopted. In this method, a risk that sensitive information, such as personal information, is mixed in the abstract question can be eliminated in principle.

The suitability determination unit 12′ determines the suitability of using the answer content stored in the conversation data storage unit 10′ as an answer to the abstract question generated by the question abstraction unit 16. The conversation data storage unit 10′ stores a database in which the content of the abstract question and the content of the abstract answer are associated with each other. Here, similar to the first embodiment, the suitability determination unit 12′ may calculate the similarity between the content of the abstract question generated by the question abstraction unit 16 and the content of a plurality of abstract questions stored in the conversation data storage unit 10′ and determine whether or not there is an abstract question having a similarity equal to or higher than a predetermined level.

When the suitability determination unit 12′ determines that it is appropriate to use the answer content stored in the conversation data storage unit 10′, the first answering unit 14A′ answers the user A who is a questioner by using the content of the abstract answer stored in the conversation data storage unit 10′.

When the suitability determination unit 12′ determines that it is not appropriate to use the answer content stored in the conversation data storage unit 10′, the user answer acquisition unit 13′ transmits the abstract question to the user terminals 200B, 200C, . . . used by a plurality of other, users B, C, . . . (question transmission unit 13A′), to obtain answers from the plurality of other users B, C, . . . (answer, reception unit 13B′).

The answer abstraction unit 17 analyzes the content of the answers obtained from the other users by the answer reception unit 13B′ and replaces the answers with abstract answers having a higher degree of abstraction. The algorithm for abstracting the answer content may be the same as the algorithm for abstracting the question content. In the example of FIG. 5, the answer abstraction unit 17 replaces the answer“□□ Gyudon set at the MMM store is recommended” received from the user B with an abstract answer “Gyudon is recommended”, and replaces the answer “ΔΔ Raman at the XYZ store” received from the user C with an abstract answer “Ramen” (step S12).

The second answering unit 14B′ selects one of the plurality oil abstract answers generated by the answer abstraction unit 17, which meets the predetermined determination criteria, to answer the user A who is a questioner. The algorithm, for selecting the answer content based on the predetermined determination criteria may be the same as that in the first embodiment. In the example of FIG. 5, the second answering unit 14B′ selects the abstract answer “Gyudon is recommended” based on the answer from the user B.

The conversation history recording unit 15′ adds and stores the content of the abstract question (abstract question when the suitability determination unit 12′ determines that it is not appropriate to use the answer content stored in the conversation data storage unit 10′ as an answer to the question), which is generated by the question abstraction unit 16, and the content of the abstract answer (abstract answer selected by the second answering unit 14B′), which is given to the questioner by the second answering unit 14B′, in the database of the conversation data storage unit 10′ so as to be associated with each other.

According to the second embodiment configured in this manner, since the content of the question received from the questioner is abstracted and transmitted to a plurality of. users, the question received by the plurality of users is not the individual specific question content. Therefore, it is easy to obtain answers from as many users as possible, so that it is possible to easily obtain an answer suitable for the question from the questioner. Furthermore, since the abstract question is also stored in the conversation data storage unit 10′, there is a high possibility that an abstract question whose similarity with the content of the abstract question generated by the question abstraction unit 16 is equal to or higher than a predetermined level will be present in the conversation data storage unit 10′. Therefore, it is also possible to increase the possibility that the answer can be automatically given by using the answer content stored in the conversation data storage unit 10′.

Furthermore, in the second embodiment, since the content of the answers received from a plurality of users is abstracted and the abstract answer is transmitted to the questioner, the answer received by the questioner is not the individual specific answer content. Therefore, since it is possible to reduce the possibility of irrelevant answers to what the questioner wants to hear, it is possible to easily obtain an answer suitable for the question asked by the questioner.

Note that, in the second embodiment, an example in which the abstraction processing is performed for both the question received by the question reception unit 11 and the answer received by the answer reception unit 13B′ has been described, but the invention is not limited thereto. For example, the abstraction processing may be performed only for the question received by the question reception unit 11. In this case, the answering unit 14 is used instead of the answering unit 14′ shown in FIG. 4. Furthermore, the conversation history recording unit 15′ adds and stores the content of the abstract question generated by the question abstraction unit 16 and the content of the answer given to the questioner by the second answering unit 14B in the database of the conversation data storage unit 10′ so as to be associated with each other.

### Third Embodiment

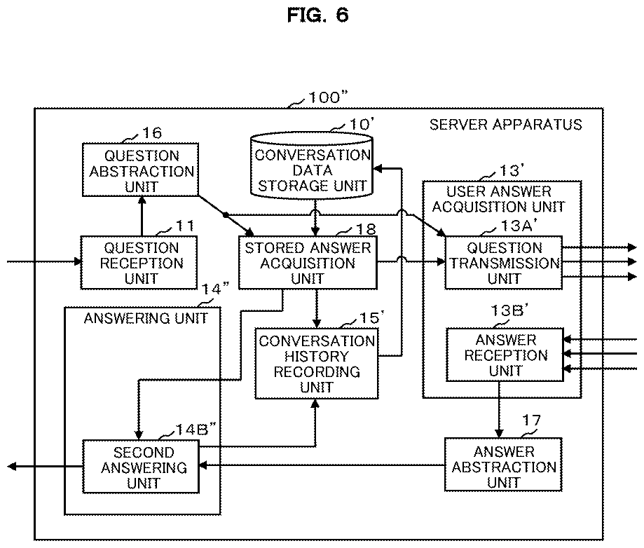

Next, a third embodiment of the invention will be described with reference to the diagrams. The overall configuration of a chat system according to the third embodiment Is the same as that in FIG. 1. A server apparatus 100″ is used instead of the server apparatus 100. FIG. 6 is a block diagram showing a functional configuration example of. the server apparatus 100″ according to the third embodiment. In FIG. 6, components denoted by the same reference numerals as those shown in FIG. 4 have the same functions, and accordingly, repealed description thereof will be omitted.

As shown in FIG. 6, the server apparatus 100″ according to the third embodiment includes a stored answer acquisition unit 18 instead of the suitability determination unit 12′ shown in FIG. 4, and includes an answering unit 14″ instead of the answering unit 14′ shown in FIG. 2. The answering unit 14″ includes only a second answering unit 14B″ and does not include the first answering unit 14A′ shown in FIG. 4.

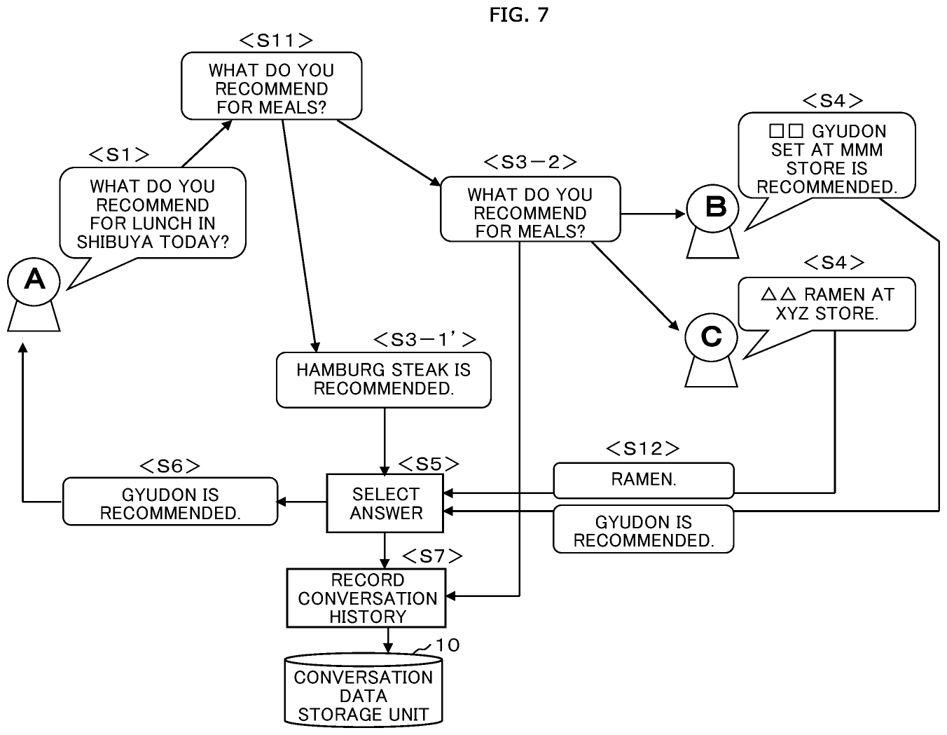

FIG. 7 is a diagram showing an operation example of the chat system according to the third embodiment. In FIG. 7, since a portion to which the same number as the step number shown in FIG. 5 is assigned has the same processing, repeated description thereof will be omitted herein. Hereinafter, the third embodiment will be described with reference to FIGS. 6 and 7.

In the third embodiment, the question abstraction unit 16 supplies an abstract question, which is generated based on the question from the questioner received from the user terminal 200, to the stored answer acquisition unit 18 and the question transmission unit 13A′. The stored answer acquisition unit 18 acquires an abstract answer corresponding to the abstract question generated by the question abstraction unit 16 from the conversation data storage unit 10′. For example, the stored answer acquisition unit 18 calculates the similarity between the content of the abstract question generated by the question abstraction unit 16 and the content of a plurality of abstract questions stored in the conversation data storage unit 10′, and acquires an abstract answer, which is stored in association with an abstract question having the highest similarity, from the conversation data storage unit 10′. In the example of FIG. 7, the stored answer acquisition unit 18 acquires an abstract answer “Hamburg steak is recommended” from, the conversation data storage unit 10′ (step S3-1′).

The question transmission unit 13A′ transmits the abstract question supplied from the question abstraction unit 16 to the plurality of user terminals 200B, 200C, . . . regardless of whether or not it is appropriate to use the abstract answer acquired from the conversation data storage unit 10′ by the stored answer acquisition unit 18 as an answer to the question received from the user terminal 2CGA.

The answering unit 14″ (second answering unit 14B″) selects one of the abstract answer (answer content stored in the conversation data storage unit 10′) acquired by the stored answer acquisition unit 18 and the abstract answer generated by the answer abstraction unit 17, which meets predetermined determination criteria, to answer the questioner. The algorithm for selecting the answer content based on the predetermined determination criteria may be the same as that in the first embodiment.

In the example of FIG. 7, the second answering unit 14B″ selects an abstract answer “Gyudon is recommended” generated based on the answer from the user B among the three abstract answers, that is, an abstract answer “Hamburg steak is recommended” acquired from the conversation data storage unit 10′ by the stored answer acquisition unit 18, an abstract answer “Gyudon is recommended” generated based on the answer from the user B, and an abstract answer “Ramen” generated based on the answer from the user C.

According to the third embodiment configured in this manner, an abstract question can be always transmitted to other users, and the best answer among the answers obtained from the other users and the answers registered in the database of the conversation data storage unit 10′ can be selected and provided to the questioner. As a result, even if an answer having a high degree of suitability for the question content is stored in the database of the conversation data storage unit 10′, when a better answer can be obtained from another user, the answer obtained from the user can be provided to the questioner. Therefore, it is possible to provide a more appropriate answer to the question from the questioner.

Note that, also in the third embodiment, the abstraction processing is performed for both the question received by the question reception unit 11 and the answer received by the answer reception unit 13B′, but the abstraction processing may be performed only for the question received by the question reception unit 11.

In the above embodiment, an example of selecting the user terminal 200 according to the predetermined selection criteria when the question received by the question reception unit 11 is transmitted to some user terminals 200 among the other user terminals 200B, 200C, . . . connected to the communication network 500 has been described. As an example of the selection criteria, the following criteria may be set.

For example, when the question reception unit 11 receives a question from a questioner, the conversation history recording unit 15′ stores the questioner and an abstract question generated by the question abstraction unit 16 in the database of the conversation data storage unit 1′ so as to be associated with each other regardless of the determination result of the suitability determination unit 12′. For example, when using the chat system, the user, is made to log in, and the user ID used by the questioner at the time of login and the abstract question are stored in the conversation data storage unit 10′ so as to be associated with each other.

The user answer acquisition unit 13′ transmits the abstract question to the user terminals 200 of a plurality of users excluding the user who is stored in the conversation data storage unit 10′ as a questioner so as to be associated with an abstract question that is the same as or similar (similarity is equal to or higher than a predetermined level) to the abstract question generated by the question abstraction unit 16 for the question received from the questioner. According to this configuration, when the user B has already asked the same kind of question as the question content of the user A before the user A who is a current questioner (when the abstract question generated for the question of the user B by the question abstraction unit 16 is the same as or similar to the abstract question generated for the question of the user A), it is possible to prevent the abstract question generated for the question from the user A from being transmitted to the user B.

Further, the following may be performed. That is, when the questioner is answered by the second answering units 14′ or 14″, flag information indicating that the questioner who is stored in the database of the conversation data storage unit 10′ in association with the abstract question has been answered is further stored. Then, when the question from the user A who is a questioner is received, it is determined whether or not the user B who has asked the same kind of question as the user A has already been answered with reference to the conversation data storage unit 10′. Here, when the user B has already been answered, the abstract question generated for the question from the user A is transmitted to also the user B, and when the user B has not been answered, the abstract question of the user A is riot transmitted to the user B. In this case, the user B may answer the question from the user A with the answer previously obtained for his or her question.

Furthermore, in the first to third embodiments, it may be determined whether or not the number of user terminals 200 connected to the communication network 500 is equal to or greater than a predetermined number, and a question may be transmitted when the number of user terminals 200 connected to the communication network 500 is equal to or greater than the predetermined number and the answer content stored in the conversation data storage unit 10 (10′) may be used when the number of user terminals 200 connected to the communication network 500 is less than the predetermined number. This is because, for example, when the number of connected users is small, such as at night, it may take a long time to obtain answers from other users. In the case of using the answer content stored in the conversation data storage unit 10 (10′) without transmitting the question, the suitability determination unit 12 (12′) may lower the predetermined level of similarity, which is used as a threshold value for determining the suitability of the answer content, to determine the suitability of using the answer content stored in the conversation data storage unit 10 (10′), and may give an answer when an appropriate answer is found.

In addition, each of the first to third embodiments is merely an example of implementation in carrying out the invention, and these should not be interpreted as limiting the technical scope of the invention. That, is, the invention can be implemented in various forms without departing from the gist or main features thereof.

1. A chat system, comprising:
a conversation data storage unit that stores a question content and an answer content as a database in association with each other;
a user answer acquisition unit that, when a question is received from a terminal of a user who is a questioner, transmits the question to terminals of a plurality of other users excluding the questioner to obtain answers from the plurality of other users; and
an answering unit that answers the questioner by using any of the answer content stored in the conversation data storage unit and the answer content obtained from the plurality of other users by the user answer acquisition unit.

2. The chat system according to claim 1, further comprising:
a suitability determination unit that, when the question is received from the terminal of the user who is the questioner, determines suitability of using the answer content stored in the conversation data storage unit as an answer to the question,
wherein the user answer acquisition unit transmits the question to the terminals of the plurality of other users when the suitability determination unit determines that it is not appropriate to use the answer content stored in the conversation data storage unit, and
the answering unit includes:
a first answering unit that answers the questioner by using the answer content stored in the conversation data storage unit when the suitability determination unit determines that it is appropriate to use the answer content stored in the conversation data storage unit; and
a second answering unit that selects one of the answer contents obtained from the plurality of other users by the user answer acquisition unit, which meets predetermined determination criteria, to answer the questioner when the suitability determination unit determines that it is not appropriate to use the answer content stored in the conversation data storage unit.

3. The chat system according to claim 1,
wherein the answering unit selects one of the answer content stored in the conversation data storage unit and the answer content obtained from the plurality of other users by the user answer acquisition unit, which meets predetermined determination criteria, to answer the questioner.

4. The chat system according to claim 1, further comprising:
a conversation history recording unit that, when the answering unit answers the questioner by using the answer content acquired by the user answer acquisition unit, adds and stores the content of the question received from the questioner and the content of the answer given to the questioner by the answering unit in a database of the conversation data storage unit so as to be associated with each other.

5. The chat system according to claim 2, further comprising:
a question abstraction unit that, when the question from the questioner is received, analyzes the content of the question and replaces the question with an abstract question having a higher degree of abstraction,
wherein the suitability determination unit determines suitability of using the answer content stored in the conversation data storage unit as an answer to the abstract question generated by the question abstraction unit, and
the user answer acquisition unit transmits the abstract question to the terminals of the plurality of other users when the suitability determination unit determines that it is not appropriate to use the answer content stored in the conversation data storage unit.

6. The chat system according to claim 3, further comprising:
a question abstraction unit that, when the question from the questioner is received, analyzes the content of the question and replaces the question with an abstract question having a higher degree of abstraction,
wherein the user answer acquisition unit transmits the abstract question to the terminals of the plurality of other users.

7. The chat system according to claim 5, further comprising:
a conversation history recording unit that, when the answering unit answers the questioner by using the answer content acquired by the user answer acquisition unit, adds and stores the content of the abstract question generated by the question abstraction unit and the content of the answer given to the questioner by the answering unit in a database of the conversation data storage unit so as to be associated with each other.

8. The chat system according to claim 5, further comprising:
an answer abstraction unit that analyzes the content of the answers obtained from the other users and replaces the answers with abstract answers having a higher degree of abstraction,
wherein the second answering unit selects one of the abstract answers generated by the answer abstraction unit, which meets the predetermined determination criteria, to answer the questioner.

9. The chat system according to claim 6, further comprising:
an answer abstraction unit that analyzes the content of the answers obtained from the other users and replaces the answers with abstract answers having a higher degree of abstraction,
wherein the answering unit selects one of the answer content stored in the conversation data storage unit and the abstract answers generated by the answer abstraction unit, which meets the predetermined determination criteria, to answer the questioner.

10. The chat system according to claim 8, further comprising:
a conversation history recording unit that, when the answering unit answers the questioner by using the abstract answer generated by the answer abstraction unit, adds and stores the content of the abstract question generated by the question abstraction unit and the content of the abstract answer given to the questioner by the answering unit in a database of the conversation data storage unit so as to be associated with each other.

11. The chat system according to claim 7,
wherein, when the question is received from the questioner, the conversation history recording unit stores the questioner and the abstract question generated by the question abstraction unit in a database of the conversation data storage unit so as to be associated with each other, and
the user answer acquisition unit transmits the abstract question to the terminals of the plurality of other users excluding the user who is stored in the conversation data storage unit as the questioner so as to be associated with an abstract question that is the same as or similar to the abstract question generated by the question abstraction unit for the question received from the questioner.

12. A chat program stored on a non-transitory computer readable medium causing a computer to function as:
a user answer acquisition unit that, when a question is received from a terminal of a user who is a questioner, transmits the question to terminals of a plurality of other users excluding the questioner to obtain answers from the plurality of other users; and
an answering unit that answers the questioner by using any of an answer content of a conversation data storage unit that stores a question content and an answer content as a database in association with each other and the answer content obtained from the plurality of other users by the user answer acquisition unit.

13. The chat system according to claim 2, further comprising:
a conversation history recording unit that, when the answering unit answers the questioner by using the answer content acquired by the user answer acquisition unit, adds and stores the content of the question received from the questioner and the content of the answer given to the questioner by the answering unit in a database of the conversation data storage unit so as to be associated with each other.

14. The chat system according to claim 3, further comprising:
a conversation history recording unit that, when the answering unit answers the questioner by using the answer content acquired by the user answer acquisition unit, adds and stores the content of the question received from the questioner and the content of the answer given to the questioner by the answering unit in a database of the conversation data storage unit so as to be associated with each other.

15. The chat system according to claim 6, further comprising:
a conversation history recording unit that, when the answering unit answers the questioner by using the answer content acquired by the user answer acquisition unit, adds and stores the content of the abstract question generated by the question abstraction unit and the content of the answer given to the questioner by the answering unit in a database of the conversation data storage unit so as to be associated with each other.

16. The chat system according to claim 9, further comprising:
a conversation history recording unit that, when the answering unit answers the questioner by using the abstract answer generated by the answer abstraction unit, adds and stores the content of the abstract question generated by the question abstraction unit and the content of the abstract answer given to the questioner by the answering unit in a database of the conversation data storage unit so as to be associated with each other.

17. The chat system according to claim 10,
wherein, when the question is received from the questioner, the conversation history recording unit stores the questioner and the abstract question generated by the question abstraction unit in a database of the conversation data storage unit so as to be associated with each other, and
the user answer acquisition unit transmits the abstract question to the terminals of the plurality of other users excluding the user who is stored in the conversation data storage unit as the questioner so as to be associated with an abstract question that is the same as or similar to the abstract question generated by the question abstraction unit for the question received from the questioner.
